(19) United States
(12) Patent Application Publication
(10) Pub. No.: US 2018/0153335 A1
(43) Pub. Date: Jun. 7, 2018

(54) BEVERAGE PREPARATION APPARATUS

(71) Applicant: Sharp Kabushiki Kaisha, Sakai City, Osaka (JP)

(72) Inventors: Yasuaki SAKANE, Sakai City, Osaka (JP); Kazuya KITATANI, Sakai City, Osaka (JP); Nahoko SAKUMASU, Sakai City, Osaka (JP); Akihiro YOSHIDOME, Sakai City, Osaka (JP); Naozumi SUGIMOTO, Sakai City, Osaka (JP)

(73) Assignee: Sharp Kabushiki Kaisha, Sakai City, Osaka (JP)

(21) Appl. No.: 15/506,111

(22) PCT Filed: Jan. 29, 2016
(86) PCT No.: PCT/JP2016/052704

§ 371 Date: Feb. 23, 2017

(30) Foreign Application Priority Data
Mar. 9, 2015 (JP) 2015-046144

(51) Int. Cl. A47J 31/44; A47J 31/46; A47J 31/40

(52) U.S. Cl. CPC A47J 31/4403; A47J 31/40; A47J 31/465

(57) ABSTRACT

A beverage preparation apparatus includes a liquid storage tank storing a liquid, a liquid supply path having one end connected to the liquid storage tank and the other end serving as a supply port, a heating device for heating the liquid in the liquid supply path, an agitation tank accommodating an agitation member agitating powders and the liquid supplied through the supply port, an agitation member drive portion rotationally driving the agitation member, and a control portion controlling the agitation member drive portion. The control portion rotationally drives the agitation member before supply of the liquid from the supply port to the agitation tank ends.

### TECHNICAL FIELD

The present invention relates to a beverage preparation apparatus for preparing a beverage by using a liquid and powders.

### BACKGROUND ART

Conventionally, beverage supply apparatuses such as a tea dispenser and a coffee machine include not only apparatuses supplying drinks by supplying powders and hot water but also apparatuses including an agitation unit for foaming milk. Since fine foams can make taste of a beverage mild, production of fine foams is demanded in recent years in which preference for beverages is diversified.

For example, Japanese Patent Laying-Open No. 2011-245315 (PTD 1) discloses an agitation unit which can agitate only a liquid such as milk and producing fine foams.

The agitation unit disclosed in PTD 1 includes an agitation blade including a blade portion in a coil shape which is formed from a series of winding portions formed from an annular wire and an agitation tank which accommodates the agitation blade.

### CITATION LIST

### Patent Document

PTD 1: Japanese Patent Laying-Open No. 2011-245315

### SUMMARY OF INVENTION

### Technical Problem

The agitation unit disclosed in PTD 1, however, aims to produce foams by agitating only a liquid, and it has not necessarily been optimal for agitation of a liquid and finely particulated powders obtained from tea leaves.

Even in an example in which a beverage is prepared by agitating powders and a liquid, simply by introducing all necessary powders into an agitation tank and supplying a whole necessary liquid into the agitation tank and thereafter agitating the powders and the liquid, powders tend to remain in a lump and foaming is poor.

The present invention was made in view of the problems as above, and an object of the present invention is to provide a beverage preparation apparatus capable of preparing a well foamed beverage while powders remaining in a lump are suppressed.

### Solution to Problem

A beverage preparation apparatus according to the present embodiment is a beverage preparation apparatus for preparing a beverage with a liquid and powders, and includes a liquid storage tank storing the liquid, a liquid supply path having one end connected to the liquid storage tank and the other end serving as a supply port supplying the liquid to the outside, a heating device for heating the liquid in the liquid supply path, an agitation tank accommodating an agitation member agitating the powders and the liquid heated by the heating device and supplied through the supply port, an agitation member drive portion rotationally driving the agitation member, and a control portion controlling the agitation member drive portion. The control portion rotationally drives the agitation member after supply of the liquid from the supply port to the agitation tank is started and before supply of the liquid to the agitation tank ends.

In the beverage preparation apparatus based on the present invention, preferably, the control portion rotationally drives the agitation member at a first speed after supply of the liquid from the supply port to the agitation tank is started and before supply of the liquid to the agitation tank ends and controls the agitation member drive portion such that a speed of rotation of the agitation member is not higher than the first speed until end of agitation by the agitation member.

In the beverage preparation apparatus based on the present invention, during a period from end of supply of the liquid until end of agitation by the agitation member, the control portion may rotationally drive the agitation member at a second speed lower than the first speed after the control portion rotationally drives the agitation member at the first speed for a prescribed time period.

In the beverage preparation apparatus based on the present invention, preferably, the control portion controls the agitation member drive portion so as to rotationally drive the agitation member after the liquid is supplied to the agitation tank until an upper end of the agitation member is immersed.

In the beverage preparation apparatus based on the present invention, preferably, the agitation member is provided at a bottom portion of the agitation tank.

### Advantageous Effects of Invention

According to the present invention, a beverage preparation apparatus capable of preparing a well foamed beverage while powders remaining in a lump are suppressed can be provided.

### BRIEF DESCRIPTION OF DRAWINGS

FIG. 1 is an overall perspective view of a beverage preparation apparatus according to a first embodiment.

FIG. 2 is an overall perspective view showing a component of the beverage preparation apparatus shown in FIG. 1.

FIG. 3 is a perspective view of a milling unit provided in the beverage preparation apparatus shown in FIG. 1.

FIG. 4 is an exploded perspective view of the milling unit shown in FIG. 3.

FIG. 5 is a vertical cross-sectional view of the milling unit shown in FIG. 3.

FIG. 6 is a cross-sectional view showing a schematic construction of the beverage preparation apparatus shown in FIG. 1.

FIG. 7 is a perspective view of an internal construction of the beverage preparation apparatus shown in FIG. 1 and an agitation unit.

FIG. 8 is a perspective view of the agitation unit shown in FIG. 7.

FIG. 9 is a perspective view showing the agitation unit shown in FIG. 8 from which an agitation cover has been removed.

FIG. 10 is a plan view showing a shape of an agitation blade shown in FIG. 6.

FIG. 11 is a perspective view showing the shape of the agitation blade shown in FIG. 6.

FIG. 12 is an exploded perspective view showing a construction of the agitation blade shown in FIG. 6.

FIG. 13 is a cross-sectional view along the line XIII-XIII shown in FIG. 10.

FIG. 14 is a perspective view showing a path formation member shown in FIG. 7.

FIG. 15 is a perspective view of the path formation member shown in FIG. 14 viewed from a side of an air outlet and a supply port.

FIG. 16 is an exploded perspective view of the path formation member shown in FIG. 14.

FIG. 17 is a cross-sectional view along the line XVII-XVII shown in FIG. 14.

FIG. 18 is a schematic diagram showing movement of steam and cooling air when hot water is supplied to the agitation unit shown in FIG. 7.

FIG. 19 is a diagram showing an agitation unit in a first comparative example.

FIG. 20 is a schematic diagram showing movement of steam and cooling air when hot water is supplied to the agitation unit shown in FIG. 19.

FIG. 21 is a diagram showing a flow of preparation of tea with the beverage preparation apparatus according to the first embodiment.

FIG. 22 is a timing chart in preparation of tea with the beverage preparation apparatus according to the first embodiment.

FIG. 23 is a diagram showing a flow of preparation of tea with a beverage preparation apparatus in a second comparative example.

FIG. 24 is a timing chart in preparation of tea with the beverage preparation apparatus in the second comparative example.

FIG. 25 is a diagram showing a flow of preparation of tea with a beverage preparation apparatus according to a second embodiment.

FIG. 26 is a timing chart in preparation of tea with the beverage preparation apparatus according to the second embodiment.

FIG. 27 is a diagram showing a flow of preparation of tea with a beverage preparation apparatus according to a third embodiment.

FIG. 28 is a timing chart in preparation of tea with the beverage preparation apparatus according to the third embodiment.

### DESCRIPTION OF EMBODIMENTS

Embodiments of the present invention will be described below in detail with reference to the drawings. In the embodiments shown below, the same or common elements have the same reference numerals allotted in the drawings and description thereof will not be repeated.

In the embodiments shown below, though a case that tea leaves are used as an object to be grated and tea is prepared as a beverage will be described by way of example, the object to be grated is not limited to tea leaves, but the embodiment can also be applied to preparation of a beverage with cereals, dried goods, and other objects to be grated. Hereinafter, tea leaves mean a solid state before grating, tea leaf powders mean grated tea leaves, and tea means a beverage obtained by agitating (mixing) tea leaf powders and hot water.

### First Embodiment

(Beverage Preparation Apparatus 1)

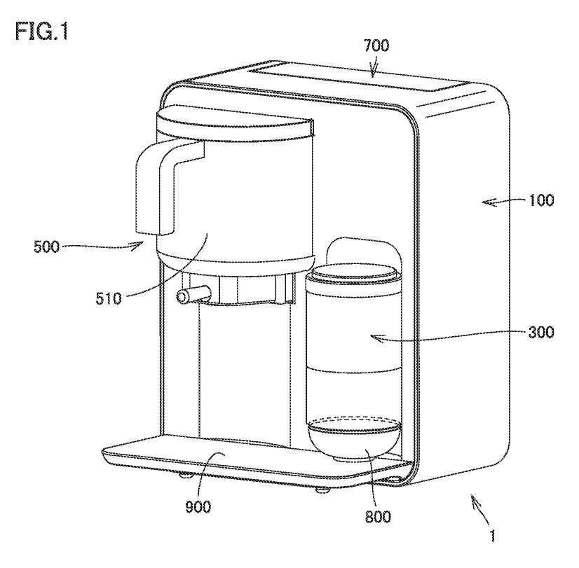

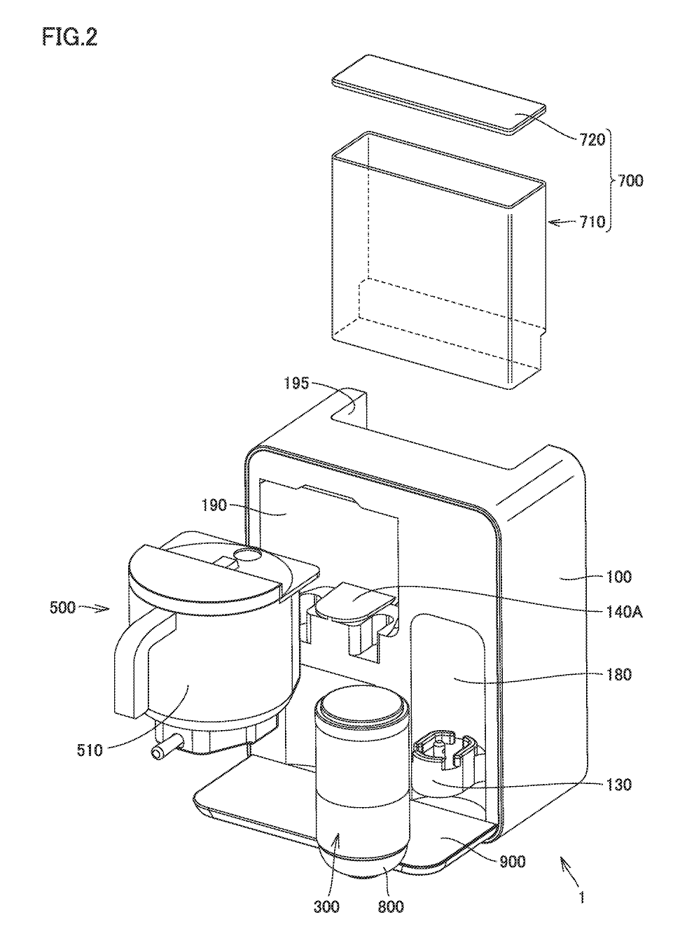

FIG. 1 is an overall perspective view of a beverage preparation apparatus according to the present embodiment. FIG. 2 is an overall perspective view showing a component of the beverage preparation apparatus shown in FIG. 1. A beverage preparation apparatus 1 according to the present embodiment will be described with reference to FIGS. 1 and 2.

As shown in FIGS. 1 and 2, beverage preparation apparatus 1 according to the present embodiment uses tea leaves as an object to be grated and obtains tea leaf powders by grating the tea leaves. The beverage preparation apparatus uses the obtained tea leaf powders for preparing tea as a beverage. Beverage preparation apparatus 1 includes an apparatus main body 100 as a housing, a milling unit 300, an agitation unit 500, a liquid storage tank 700, a tea leaf powder tray 800, and a placement base 900. Placement base 900 is provided to protrude forward on a front side in a lower portion of apparatus main body 100 and a cup (not shown) and tea leaf powder tray 800 can be placed thereon. Tea leaf powder tray 800 is provided such that a user can hold and move the tray.

(Milling Unit 300)

Milling unit 300 is removably attached to a milling unit attachment portion 180 provided on a front surface side of apparatus main body 100. Milling unit 300 is arranged at a distance from an agitation tank 510 so as not to be superimposed on agitation tank 510 under agitation tank 510 included in agitation unit 500, for example, when viewed from the front.

A milling driving force coupling mechanism 130 is provided in milling unit attachment portion 180 so as to protrude forward and milling unit 300 is removably attached to this milling driving force coupling mechanism 130. Milling unit 300 obtains driving force for milling tea leaves representing an object to be grated by being coupled to milling driving force coupling mechanism 130.

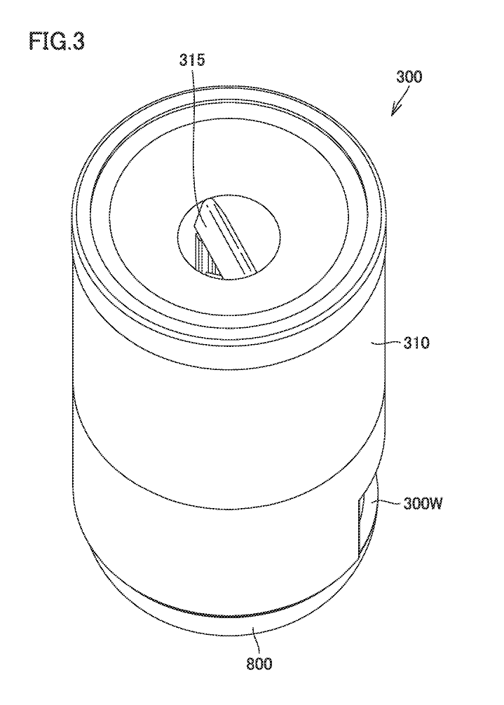

Tea leaves introduced from an upper portion of milling unit 300 into milling unit 300 are finely grated in milling unit 300. The grated tea leaves are dropped and collected as tea leaf powders on tea leaf powder tray 800 placed below milling unit 300. A detailed structure of milling unit 300 will be described later with reference to FIGS. 3 to 5.

(Liquid Storage Tank 700)

Liquid storage tank 700 is removably attached to a liquid storage tank attachment portion 195 provided on an upper surface side of apparatus main body 100. Liquid storage tank 700 includes a tank main body 710 having an opening in an upper surface and a lid portion 720 closing the opening in the upper surface of tank main body 710. Liquid storage tank 700 stores such a liquid as water for supply into agitation tank 510 of agitation unit 500.

(Agitation Unit 500)

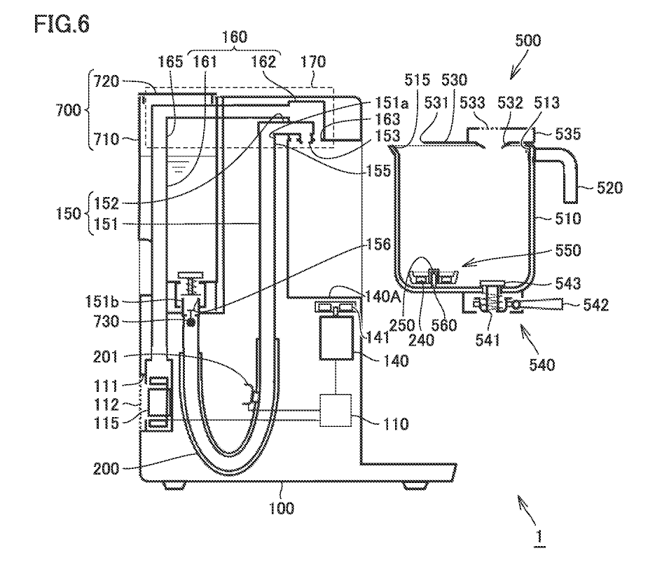

Agitation unit 500 includes agitation tank 510 as a tank to which hot water heated by a heating device 200 (see FIG. 6) which will be described later is supplied and an agitation blade 550 (see FIG. 6) as an agitation member which will be described later. Agitation tank 510 is a container for agitating a liquid and powders. Agitation tank 510 is removably attached to an agitation unit attachment portion 190 provided on the front surface side of apparatus main body 100. Agitation tank 510 is attached to agitation unit attachment portion 190 so as to protrude from apparatus main body 100 in a direction intersecting with a vertical direction. Specifically, agitation tank 510 is attached such that a part of agitation tank 510 protrudes forward from a front surface of apparatus main body 100. A detailed structure of agitation unit 500 will be described later with reference to FIGS. 6 to 9.

An agitation motor contactless table 140A is provided in agitation unit attachment portion 190. Agitation unit 500 is placed on agitation motor contactless table 140A. Agitation blade 550 provided in agitation unit 500 is rotated by an agitation motor unit 140 as an agitation member drive portion (see FIG. 6) and a magnet 141 (see FIG. 6) coupled thereto which are accommodated in apparatus main body 100 so as to be located below agitation motor contactless table 140A.

(Structure of Milling Unit 300)

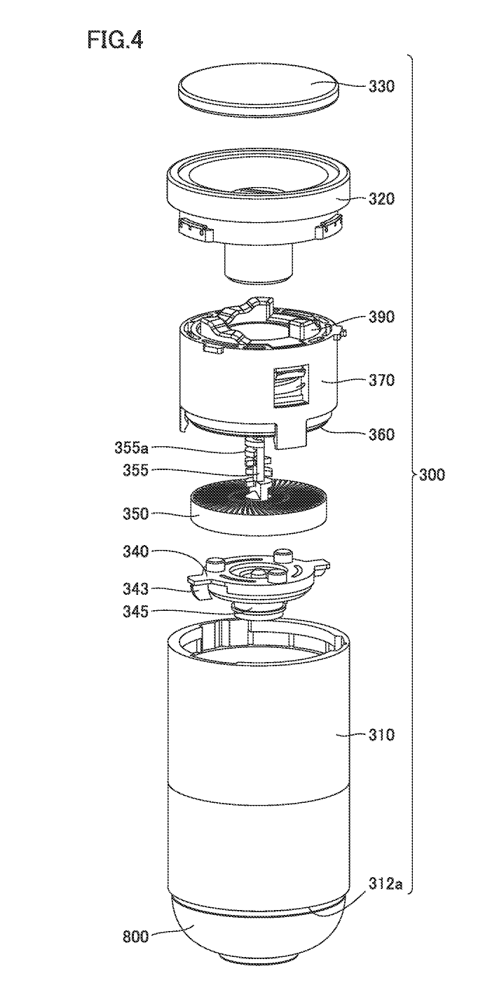

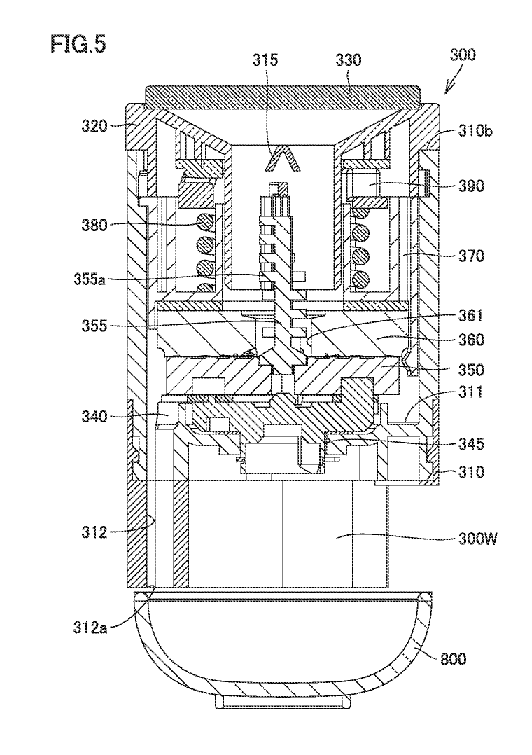

FIG. 3 is a perspective view of the milling unit provided in the beverage preparation apparatus shown in FIG. 1. FIG. 4 is an exploded perspective view of the milling unit shown in FIG. 3. FIG. 5 is a vertical cross-sectional view of the milling unit shown in FIG. 3. A structure of milling unit 300 will be described with reference to FIGS. 3 to 5.

As shown in FIGS. 3 to 5, milling unit 300 has a milling case 310 having a cylindrical shape as a whole and a window 300W for coupling in which milling driving force coupling mechanism 130 is inserted is provided in a side surface below. A discharge outlet 312a is formed at a lowermost end portion of milling case 310 from which powders of tea leaves grated by milling unit 300 are discharged.

A lower mill support portion 340, a lower mill 350, and an upper mill 360 are sequentially provided from below, in the inside of milling case 310. A milling shaft 345 extending downward is provided on a lower surface of lower mill support portion 340 and coupled to milling driving force coupling mechanism 130 to thereby rotationally drive lower mill 350. A powder scraper portion 343 is provided to protrude horizontally at a peripheral edge of lower mill support portion 340.

A core 355 extending upward along a core of a rotation axis is provided in a central portion of lower mill 350. Upper mill 360 is held by an upper mill holding member 370, and a spring 380 and a spring holding member 390 pressing upper mill 360 downward are accommodated in upper mill holding member 370. Core 355 provided in lower mill 350 extends upward to pass through upper mill 360. A tip end side of core 355 is located in a hopper 320.

A safety rib 315 in a shape projecting upward is formed above core 355. Safety rib 315 of a prescribed size is provided such that tea leaves can be introduced into hopper 320. Though safety rib 315 has a substantially triangular cross-section at an angle acute in an upward direction, limitation to this shape is not intended.

Hopper 320 for supplying an object to be grated in between upper mill 360 and lower mill 350 is attached on a side of an upper end opening portion 310b of milling case 310. Hopper 320 is in a shape of a funnel.

In grating tea leaves, hopper 320 is preferably covered with a cover portion 330. Thus, after tea leaves are introduced into hopper 320, entry of a foreign matter into milling unit 300 can be prevented. Scattering of grated tea leaves to the outside can be prevented. When tea leaves are to be introduced, cover portion 330 is removed from hopper 320.

Tea leaves introduced into hopper 320 are guided in between upper mill 360 and lower mill 350 as a helical blade 355a provided in core 355 rotates with rotation of lower mill 350. Tea leaves guided in between upper mill 360 and lower mill 350 are grated and fall downward in a form of tea leaf powders from a circumference of upper mill 360 and lower mill 350.

Some of fallen tea leaf powders is discharged through a discharge path 312 into tea leaf powder tray 800 from discharge outlet 312a. Other fallen tea leaf powders are stored in a storage portion 311. Tea leaf powders in storage portion 311 are transported to discharge path 312 and discharged from discharge outlet 312a into tea leaf powder tray 800 as powder scraping portion 343 rotates with rotation of lower mill support portion 340.

(Internal Structure of Beverage Preparation Apparatus 1)

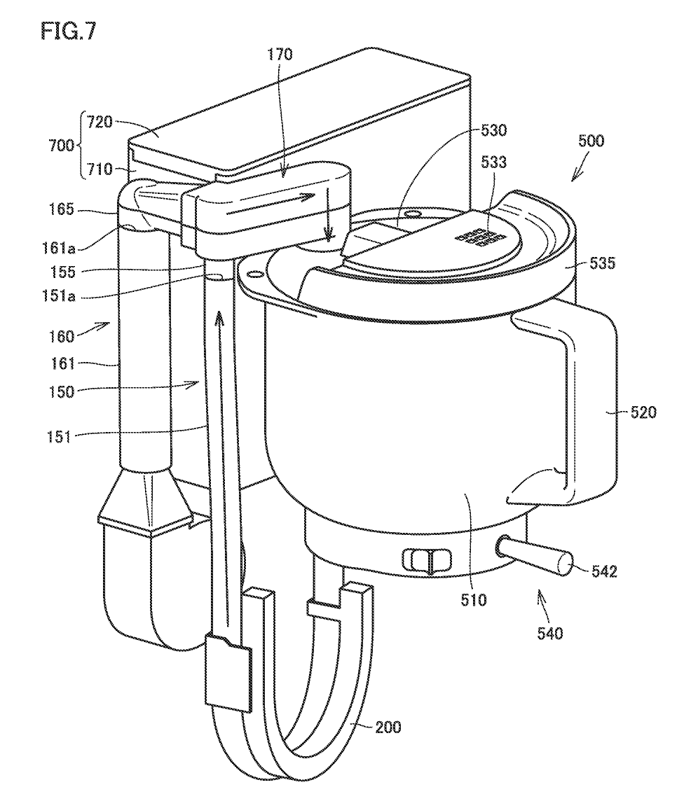

FIG. 6 is a cross-sectional view showing a schematic construction of the beverage preparation apparatus shown in FIG. 1. FIG. 7 is a perspective view of an internal construction of the beverage preparation apparatus shown in FIG. 1 and the agitation unit. An internal structure of beverage preparation apparatus 1 will be described with reference to FIGS. 6 and 7.

As shown in FIGS. 6 and 7, beverage preparation apparatus 1 includes a control portion 110, a liquid supply path 150, an air passage path 160, heating device 200, a thermistor 201, and a fan 115. Control portion 110 controls operations of heating device 200, fan 115, milling driving force coupling mechanism 130, and agitation motor unit 140.

Liquid supply path 150 is accommodated in apparatus main body 100. Liquid supply path 150 is connected to liquid storage tank 700. Liquid supply path 150 has one end connected to liquid storage tank 700 and the other end serving as a supply port 153 supplying hot water into agitation tank 510.

Liquid supply path 150 includes a supply nozzle 152 and a connection pipe 151. Supply nozzle 152 has supply port 153 on a tip end side and has a fitting portion 155 on a side of connection pipe 151. Supply port 153 is provided to be opposed to the bottom portion of agitation tank 510 while agitation tank 510 is attached to agitation unit attachment portion 190. Supply port 153 is arranged above agitation blade 550.

Fitting portion 155 is provided to removably be fitted to a side of one end 151a of connection pipe 151. Fitting portion 155 is in a cylindrical shape. By fitting fitting portion 155 to the side of one end 151a of connection pipe 151, connection pipe 151 is connected to supply nozzle 152.

Connection pipe 151 connects supply nozzle 152 and liquid storage tank 700 to each other. Connection pipe 151 extends once downward from a bottom surface of liquid storage tank 700 and extends upward in a U shape. A check valve 730 is provided on a side of the other end 151b of connection pipe 151. Check valve 730 prevents backflow of a liquid in liquid supply path 150 to liquid storage tank 700.

Heating device 200 is provided in a region intermediate in connection pipe 151 of liquid supply path 150. Heating device 200 heats water (liquid) in liquid supply path 150. A liquid in liquid supply path 150 is heated by heating device 200 and the liquid is supplied to agitation tank 510 when a pressure in liquid supply path 150 is equal to or higher than a prescribed pressure. For sterilization of water, water is heated to a temperature not lower than 80° C.

Thermistor 201 is provided in the vicinity of heating device 200. Thermistor 201 inputs information on a temperature of heating device 200 to control portion 110. Control portion 110 determines whether or not a temperature of heating device 200 is equal to or higher than a prescribed temperature based on the information on a temperature from thermistor 201.

Air passage path 160 is a path for sending air into agitation tank 510. Air passage path 160 is accommodated in apparatus main body 100. Air passage path 160 includes an air inlet 111 and an air outlet 163. Air inlet 111 is provided on a side of a rear surface of apparatus main body 100. Air inlet 111 may be provided with an air filter 112 catching dust contained in air.

Air outlet 163 is provided to be opposed to the bottom portion of agitation tank 510 while agitation tank 510 is attached to agitation unit attachment portion 190. Air outlet 163 is provided to surround at least a part of a periphery of supply port 153. In this case, a central axis of air outlet 163 and a central axis of supply port 153 are preferably coaxial.

Air outlet 163 is provided to be able to impinge air at least onto hot water supplied from supply port 153 into agitation tank 510 (hot water which falls into agitation tank 510) in supply of hot water heated by heating device 200 to agitation tank 510.

Air passage path 160 includes an air duct 162 and a connection duct 161. Air duct 162 has air outlet 163 described above on a tip end side and has an insertion portion 165 on a side of connection duct 161. Insertion portion 165 is in a cylindrical shape. By inserting insertion portion 165 into the side of one end 161a of connection duct 161, connection duct 161 is connected to air duct 162. Connection duct 161 connects air duct 162 and air inlet 111 to each other.

Fan 115 is arranged in air passage path 160. Fan 115 sends air taken through air inlet 111 toward air outlet 163. A fan of such a type as a sirocco fan, a propeller fan, or a turbo fan can be adopted as appropriate as fan 115.

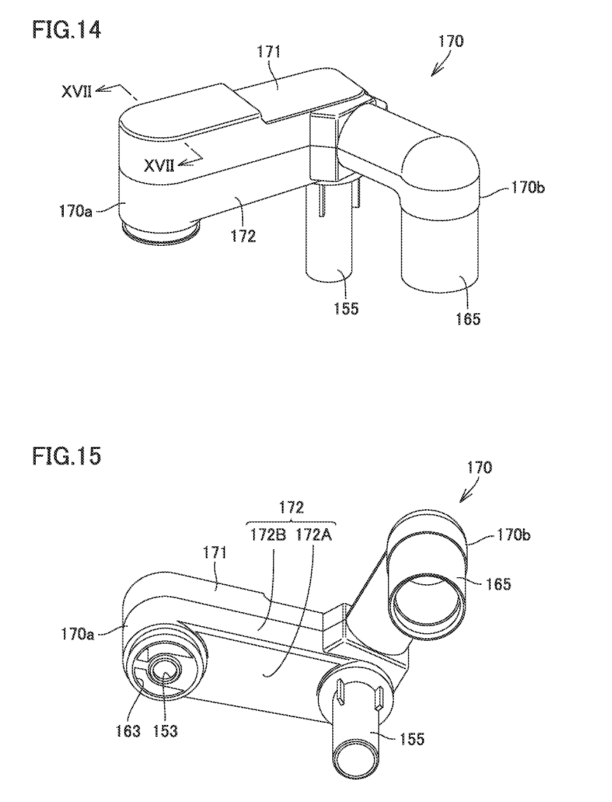

Supply nozzle 152 and air duct 162 are formed from path formation member 170. A detailed structure of path formation member 170 will be described later with reference to FIGS. 14 to 18.

(Detailed Structure of Agitation Unit 500)

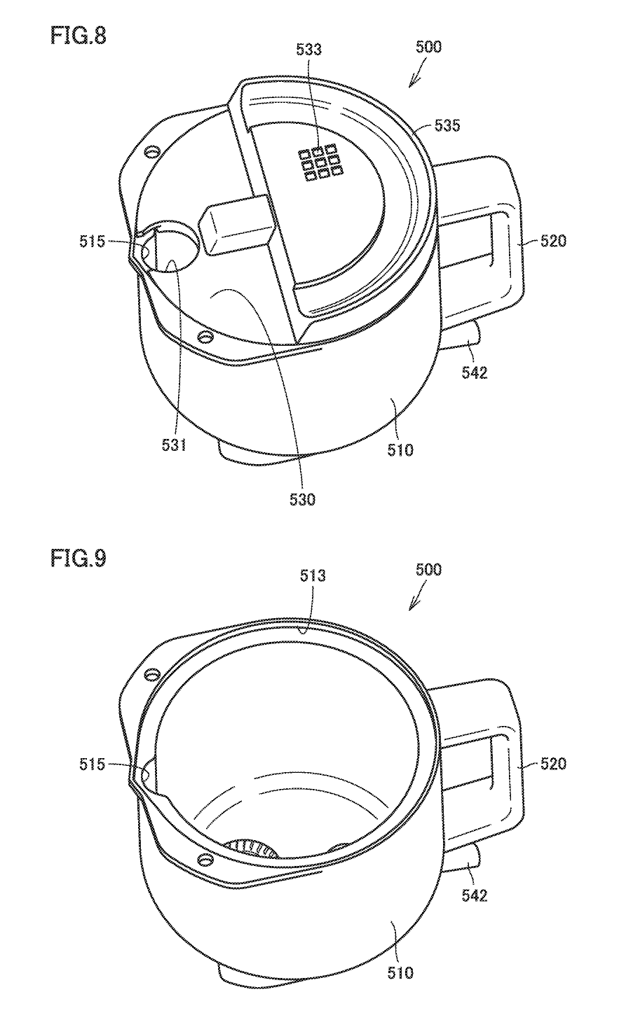

FIG. 8 is a perspective view of the agitation unit shown in FIG. 7. FIG. 9 is a perspective view showing the agitation unit shown in FIG. 8 from which an agitation cover has been removed. A detailed structure of agitation unit 500 will be described with reference to FIGS. 6 to 9.

As shown in FIGS. 6 to 9, agitation unit 500 includes agitation tank 510, agitation blade 550, an agitation cover 530, and a discharge port opening and closing mechanism 540. Agitation tank 510 is in a shape of a container having an opening upper surface. Agitation tank 510 has an opening portion 513 provided in an upper portion and a lip portion 515 provided to protrude outward.

Agitation tank 510 accommodates agitation blade 550. Agitation tank 510 includes an exterior holder (not shown) made, for example, of a resin and a thermally insulated tank held by the exterior holder. A grip 520 is provided in agitation tank 510. Grip 520 is formed integrally with the exterior holder with a resin.

Agitation cover 530 is removably attached to opening portion 513 of agitation tank 510. Agitation cover 530 is provided with a hot water supply inlet 531 and a powder inlet 532. Powder inlet 532 is a site for introducing powders of tea leaves grated by milling unit 300.

Hot water supply inlet 531 is provided to be able to be opposed to supply port 153 of supply nozzle 152 and air outlet 163 of air duct 162. Hot water supply inlet 531 guides hot water poured from supply nozzle 152 into agitation tank 510 and guides air sent from air outlet 163 into agitation tank 510. Hot water supply inlet 531 is provided to communicate with lip portion 515.

As hot water supply inlet 531 communicates with lip portion 515, a beverage in agitation tank 510 can be poured to the outside from lip portion 515 and hot water supply inlet 531 by removing agitation unit 500 from agitation unit attachment portion 190 and inclining agitation unit 500. Hot water supply inlet 531 in the present embodiment also functions as a lip.

A slide cover 535 covering powder inlet 532 so as to be able to open and close the inlet is attached to agitation cover 530. Slide cover 535 is provided as being slidable over agitation cover 530.

In introduction of powders from powder inlet 532 into agitation tank 510, slide cover 535 is slid so as to expose powder inlet 532. Powder inlet 532 is thus opened.

When introduction of powders into agitation tank 510 ends, slide cover 535 is slid so as to cover powder inlet 532 with slide cover 535. Powder inlet 532 is thus closed. In the closed state, entry of a foreign matter into agitation tank 510 through powder inlet 532 from the outside can be prevented.

Slide cover 535 does not have to be provided as being slidable so long as it can cover powder inlet 532 to be able to open and close the inlet, and it may removably be attached to agitation cover 530.

Slide cover 535 has a hole portion 533 communicating with powder inlet 532 while the slide cover covers powder inlet 532. Hole portion 533 allows steam of hot water supplied into agitation tank 510 and air sent into agitation tank 510 through air outlet 163 to escape to the outside by communicating with powder inlet 532.

Agitation blade 550 is placed on the bottom portion of agitation tank 510. A rotation shaft 560 extending upward is provided on the bottom portion of agitation tank 510, and a cylindrical core 250 of agitation blade 550 is inserted in this rotation shaft 560.

A magnet 240 is embedded in agitation blade 550. In agitation motor contactless table 140A, magnet 240 embedded in agitation blade 550 and magnet 141 provided on a side of agitation motor unit 140 are magnetically coupled in a contactless state, so that rotational driving force of agitation motor unit 140 is transmitted to agitation blade 550.

Discharge port opening and closing mechanism 540 includes an opening and closing nozzle 543 which closes a discharge port 541 provided at the bottom portion of agitation tank 510 so as to be able to open and close discharge port 541 and an operation lever 542 controlling a position of opening and closing nozzle 543. Opening and closing nozzle 543 is biased to close discharge port 541 by a biasing member (not shown) such as a spring in a normal state. When a user moves operation lever 542 against biasing force, opening and closing nozzle 543 moves to open discharge port 541. Thus, tea in agitation tank 510 is poured into a cup (not shown) placed on placement base 900.

In the present embodiment, whether to pour a prepared beverage to the outside from discharge port 541 while agitation unit 500 is attached to apparatus main body 100 or to pour the beverage to the outside from lip portion 515 of agitation tank 510 with agitation unit 500 having been removed from the apparatus main body can be selected as appropriate. Therefore, convenience is significantly improved.

Though an example in which agitation tank 510 is constituted of an exterior holder and a thermally insulated tank in agitation unit 500 described above has been described by way of example, limitation thereto is not intended and the agitation tank may consist of a thermally insulated tank. Instead of a thermally insulated tank, a container which is not thermally insulated but is heat resistant may be employed.

(Agitation Blade 550)

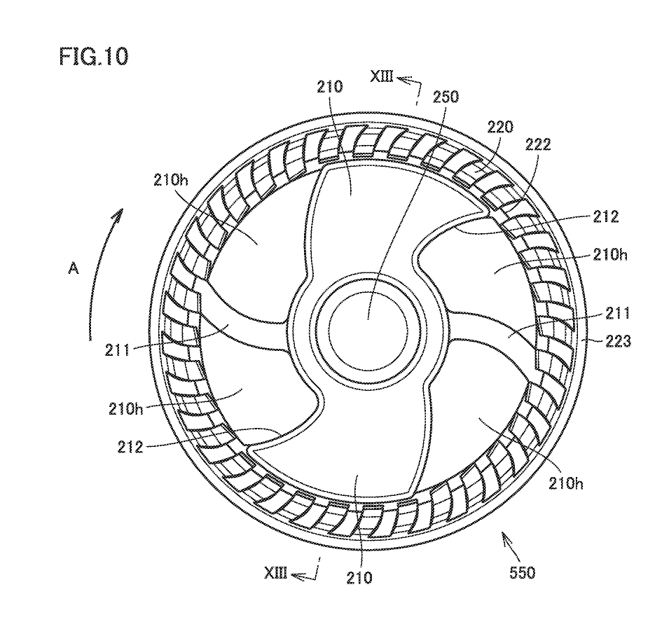

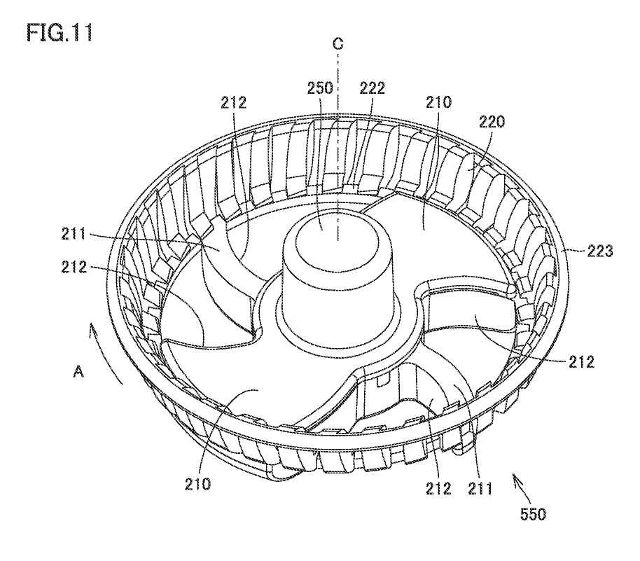

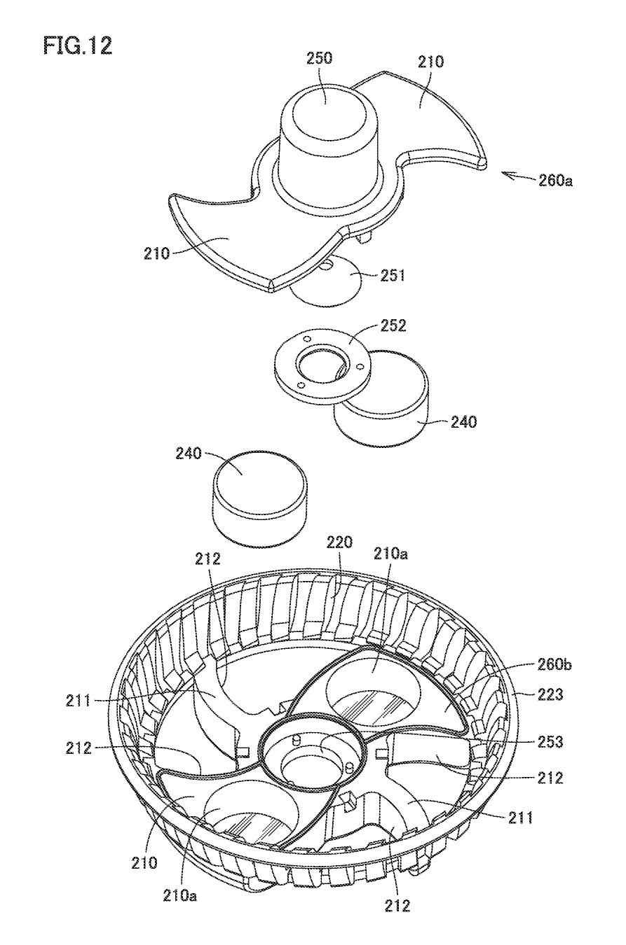

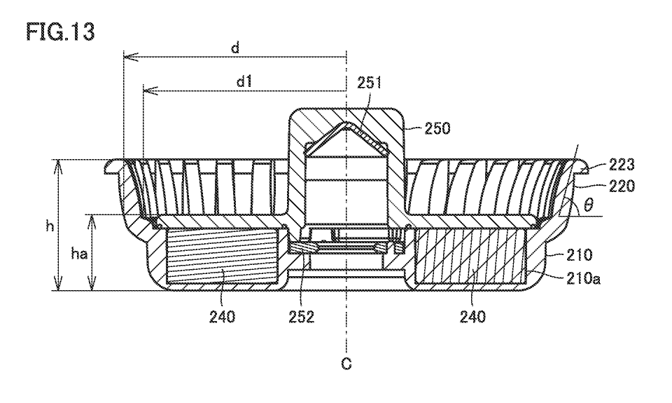

FIG. 10 is a plan view showing a shape of the agitation blade shown in FIG. 6. FIG. 11 is a perspective view showing the shape of the agitation blade shown in FIG. 6. FIG. 12 is an exploded perspective view showing a construction of the agitation blade shown in FIG. 6. FIG. 13 is a cross-sectional view along the line XIII-XIII shown in FIG. 10. Agitation blade 550 will be described with reference to FIGS. 10 to 13.

As shown in FIGS. 10 and 11, agitation blade 550 includes in the center, cylindrical core 250 in which a rotation axis is inserted. Cylindrical core 250 implements a rotation portion having a central axis of rotation (C). A pair of first paddles 210 provided at positions opposed to each other at an angle of 180 degrees and a pair of second paddles 211 provided at positions opposed to each other at an angle of 180 degrees, each at a position rotated by 90 degrees from first paddle 210, extend radially from an outer circumferential surface of cylindrical core 250.

A lower auxiliary ring 222 is provided on an outer circumferential surface of the pair of first paddles 210 and an outer circumferential surface of the pair of second paddles 211. Lower auxiliary ring 222 has such a shape as not producing a resistance in a direction of rotation (a direction shown with an arrow A in the figures). A plurality of blade portions 220 extending toward an upper surface (a first surface) of first paddle 210 and second paddle 211 are provided on lower auxiliary ring 222 so as to surround central axis of rotation C. The plurality of blade portions 220 are provided to be in rotation symmetry with respect to central axis of rotation C. An upper end portion of blade portion 220 is coupled to an upper auxiliary ring 223. Upper auxiliary ring 223 also has a shape not producing a resistance in the direction of rotation, similarly to lower auxiliary ring 222. A detailed shape of blade portion 220 will be described later.

The pair of first paddles 210 has a curved paddle surface 212, which has a prescribed thickness downward (toward a second surface), has a curved shape recessed toward a downstream side when viewed in the direction of rotation, and contributes to agitation in the direction of rotation (the direction shown with arrow A in the figures). Similarly, second paddle 211 has curved paddle surface 212 formed, which has a prescribed thickness downward (toward the second surface), has a curved shape recessed toward the downstream side when viewed in the direction of rotation, and contributes to agitation in the direction of rotation (the direction shown with arrow A in the figures). Paddle surfaces 212 are provided at four locations, and four spaces 210h in total are provided between first paddles 210 and second paddles 211. Magnet 240 is embedded in the pair of first paddles 210.

As shown in FIGS. 12 and 13, cylindrical core 250 and the pair of first paddles 210 include an integrally formed cover 260a. A cylindrical accommodation portion 210a for accommodating magnet 240 is provided in a paddle main body 260b of first paddle 210. Rotation is transmitted with magnetic force to magnet 240 embedded in the pair of first paddles 210, by a contactless rotational drive mechanism (agitation motor unit 140 and magnet 141). In order to enhance holding capability owing to magnetic force during rotational drive, magnets 240 are desirably provided at two locations.

A through hole 253 in which the rotation axis is inserted is provided between the pair of first paddles 210. A conical cap 251 is accommodated in cylindrical core 250 for smooth rotation of agitation blade 550 with a tip end of the rotation axis being in point contact. A ring seal 252 for ensuring water tightness is fitted in between cover 260a and paddle main body 260b.

A shape of blade portion 220 will now be described with reference to FIG. 13. An angle of inclination θ spreading outward in an upward direction is provided in blade portion 220. Angle of inclination θ is set, for example, approximately to 75 degrees. Depending on angle of inclination θ, agitation blade 550 can obtain high agitation force with an outer shape being the same, or load imposed on a rotational drive portion can be lowered with agitation force being the same.

Depending on angle of inclination θ, ease in cleaning of agitation blade 550 improves. An area where a height ha of first paddle 210 and second paddle 211 produces a resistance (contributes to agitation force) in the direction of rotation as shown in FIG. 13 with respect to a total height h of agitation blade 550 is defined. In the present embodiment, desirably, h=9.5 mm and ha=5.5 mm. Blade portion 220 desirably has an inner diameter d1=φ30 mm and an outer diameter d=φ32 mm.

According to such a construction, agitation blade 550 can achieve both of an effect of foaming by intake of air from a water surface in an agitation operation and an effect of agitation by paddle surfaces 212 of first paddle 210 and second paddle 211. For example, foaming and agitation performance for a minimum volume of supply of a liquid of 150 cc can be confirmed in agitation tank 510 having inner diameter φ of 100 mm.

In rotation of agitation blade 550, as a result of an agitation action by agitation blade 550, force in a direction substantially orthogonal to central axis of rotation C is applied to the liquid. Consequently, a liquid surface in a central portion including the central axis of rotation is lowered, and an upper portion of agitation blade 550 is exposed through the liquid surface.

In a region of agitation blade 550 exposed through the liquid surface, air can be taken into the liquid. At the same time, air and the liquid to be agitated are sent from the central portion to an outer circumferential portion of agitation blade 550, and powders and the liquid are agitated while air is efficiently taken into the liquid.

As blade portion 220 of agitation blade 550 passes by an interface between air and the liquid surface, large foams are crushed and fine foams can be created.

The construction of agitation blade 550 is not limited to the construction as above, and modification as appropriate can be made so long as a shape of a sirocco fan which has a blade portion provided to be able to take in air and an agitation contribution portion contributing to agitation is provided.

(Path Formation Member 170)

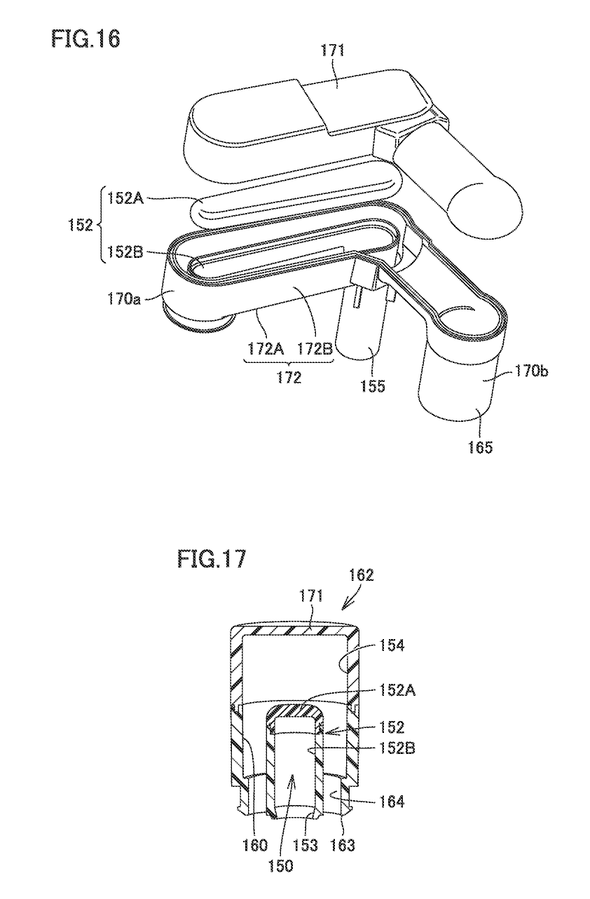

FIG. 14 is a perspective view showing the path formation member shown in FIG. 7. FIG. 15 is a perspective view of the path formation member shown in FIG. 14 viewed from a side of the air outlet and the supply port. FIG. 16 is an exploded perspective view of the path formation member shown in FIG. 14. FIG. 17 is a cross-sectional view along the line XVII-XVII shown in FIG. 14. Path formation member 170 will be described with reference to FIGS. 14 to 17.

Path formation member 170 has an upper member 171, a lower member 172, and an intermediate member 152A (see FIG. 16). Path formation member 170 is in a substantially L shape. Supply port 153 (see FIG. 15) and air outlet 163 (see FIG. 15) are provided on the side of one end 170a of path formation member 170.

Fitting portion 155 in a cylindrical shape is provided in the vicinity of a bent portion of path formation member 170. Fitting portion 155 is a part of supply nozzle 152 as described above and constitutes a part of liquid supply path 150 for discharging hot water.

Cylindrical insertion portion 165 is provided on the side of the other end 170b of path formation member 170. Insertion portion 165 is a part of air duct 162 as described above and constitutes a part of air passage path 160 for sending air.

The inside of path formation member 170 from the bent portion to one end 170a has a double wall structure. A part of air duct 162 is provided from the bent portion to one end 170a so as to surround supply nozzle 152.

Lower member 172 is provided to open upward. Lower member 172 includes fitting portion 155 and insertion portion 165 described above, a partition portion 152B, a bottom portion 172A, and a peripheral wall portion 172B.

Partition portion 152B is in an oval shape and opens upward. Partition portion 152B is provided to stand from bottom portion 172A in a substantially central portion of lower member 172 extending from the bent portion to one end 170a. Partition portion 152B is provided to connect fitting portion 155 and supply port 153 to each other and to separate supply port 153 and air outlet 163 from each other.

Peripheral wall portion 172B is provided to stand from a peripheral edge of bottom portion 172A. Peripheral wall portion 172B is provided to connect insertion portion 165 and air outlet 163 to each other and to surround partition portion 152B.

Intermediate member 152A is a site closing an opening in an upper surface of partition portion 152B. As intermediate member 152A closes the opening in the upper surface of partition portion 152B, partition portion 152B, intermediate member 152A, and bottom portion 172A define a space communicating with supply port 153 and fitting portion 155. Supply nozzle 152 is thus formed.

Upper member 171 is a site closing an opening in an upper surface of lower member 172. As upper member 171 closes the opening in the upper surface of lower member 172 while supply nozzle 152 is formed, a space separated from the space communicating with supply port 153 and fitting portion 155 described above is provided in path formation member 170. Air duct 162 is thus formed.

The separated space is provided to surround the periphery of supply nozzle 152 except for a side of bottom portion 172A. Therefore, before hot water is supplied from supply port 153 into agitation tank 510, hot water which passes through supply nozzle 152 can be cooled by air sent into air duct 162 with partition portion 152B and intermediate member 152A constituting supply nozzle 152 being interposed.

As upper member 171 closes the opening in the upper surface of lower member 172, an air outlet chamber 154 (see FIG. 17) communicating with air outlet 163 on a side of air outlet 163 and changing a direction of air sent by fan 115 toward agitation tank 510 is provided in air passage path 160.

Air outlet chamber 154 is provided to be able to drain from air outlet 163 toward agitation tank 510, condensation water which adheres to air outlet chamber 154 due to entry from air outlet 163 into air outlet chamber 154 and condensation of vapor from hot water supplied into agitation tank 510.

Specifically, for example, an inner wall portion 164 of air duct 162 in a portion defining air outlet 163 is inclined so as to decrease in inner diameter downward. Bottom portion 172A of lower member 172 in a portion extending from the bent portion toward one end 170a is also preferably provided to be inclined downward from the side of the bent portion toward air outlet 163.

Condensation water which adheres to air outlet chamber 154 runs along the inclined surface of bottom portion 172A and the inclined surface of inner wall portion 164 and is drained through air outlet 163. According to such a construction, condensation water can be prevented from moving toward fan 115. Consequently, a portion driving fan 115 can be prevented from short-circuiting.

By employing path formation member 170 constructed as above, not only hot water supplied into agitation tank 510 but also hot water being supplied into agitation tank 510 can be cooled. Therefore, hot water can efficiently be cooled by removing latent heat of evaporation of hot water by positively bringing hot water into direct contact with air in a portion where hot water is at a relatively high temperature.

(Movement of Steam and Cooling Air During Supply of Hot Water)

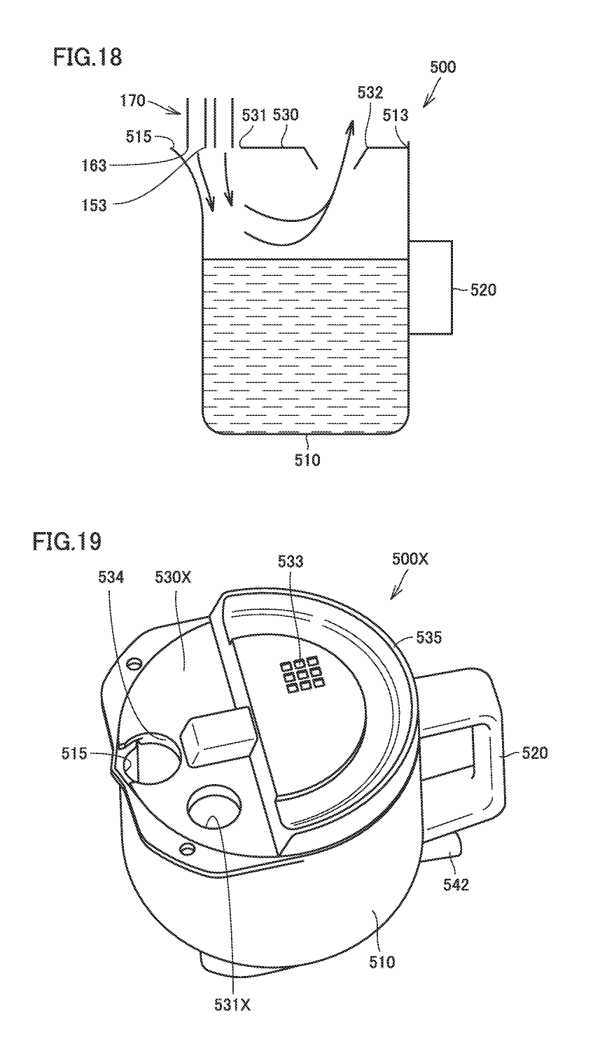

FIG. 18 is a schematic diagram showing movement of steam and cooling air when hot water is supplied to the agitation unit shown in FIG. 7. FIG. 18 does not show slide cover 535 for the sake of convenience. FIG. 18 is a schematic diagram showing movement of steam in supply of hot water to agitation unit 500.

During supply of hot water, agitation unit 500 is attached to agitation unit attachment portion 190 and hot water supply inlet 531 is opposed to a tip end of path formation member 170 where supply port 153 and air outlet 163 are provided. Thus, lip portion 515 and hot water supply inlet 531 communicating therewith are substantially closed by the tip end of path formation member 170.

When cooling air is sent from air outlet 163 into agitation tank 510 while hot water is supplied from supply port 153 into agitation tank 510, steam from hot water and cooling air are discharged to the outside through powder inlet 532 and hole portion 533 in slide cover 535 as shown with an arrow in FIG. 18 because the side of hot water supply inlet 531 is closed.

As shown in FIG. 6, hole portion 533 in slide cover 535 is provided at a position distant from apparatus main body 100. Therefore, steam and cooling air including the steam can be prevented from entering apparatus main body 100. Thus, condensation in apparatus main body 100 can be prevented and electronic components in apparatus main body 100 can be prevented from being broken due to short-circuiting or corrosion.

### First Comparative Example

(Agitation Unit 500X)

FIG. 19 is a diagram showing an agitation unit in a first comparative example. An agitation unit 500X in the first comparative example will be described with reference to FIG. 19.

Agitation unit 500X in the first comparative example is different from agitation unit 500 according to the first embodiment in construction of an agitation cover 530X but substantially the same in other features.

Agitation cover 530X of agitation unit 500X includes an opening portion 534 provided to expose lip portion 515 of agitation tank 510, a hot water supply inlet 531X provided at a position distant from lip portion 515 without communicating with lip portion 515, and a powder inlet (not shown).

### Movement of Steam and Cooling Air During Supply of Hot Water in First Comparative Example

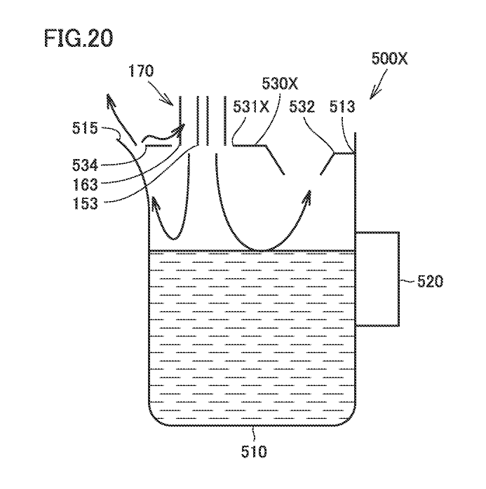

FIG. 20 is a schematic diagram showing movement of steam and cooling air when hot water is supplied to the agitation unit shown in FIG. 19. Movement of steam and cooling air in supply of hot water to agitation unit 500X in the first comparative example will be described with reference to FIG. 20.

As shown in FIG. 20, during supply of hot water, agitation unit 500X is attached to agitation unit attachment portion 190 and hot water supply inlet 531X is opposed to the tip end of path formation member 170 where supply port 153 and air outlet 163 are provided.

Though hot water supply inlet 531 is closed substantially by the tip end of path formation member 170 in the first comparative example, lip portion 515 and opening portion 534 exposing the same remain opened.

Therefore, when cooling air is sent from air outlet 163 into agitation tank 510 while hot water is supplied from supply port 153 into agitation tank 510, steam from hot water and cooling air are discharged to the outside through hole portion 533 communicating with powder inlet 532 and opening portion 534 in agitation cover 530X as shown with an arrow in FIG. 20.

While agitation unit 500X is attached to agitation unit attachment portion 190, lip portion 515 and opening portion 534 are oriented toward apparatus main body 100. Apparatus main body 100 is provided with a through hole for exposing the tip end of path formation member 170 through apparatus main body 100.

Therefore, steam which has escaped from opening portion 534 and cooling air including the steam may enter apparatus main body 100 through the through hole provided in apparatus main body 100. Thus, electronic components in apparatus main body 100 may be broken due to short-circuiting or corrosion.

### Preparation of Tea in First Embodiment

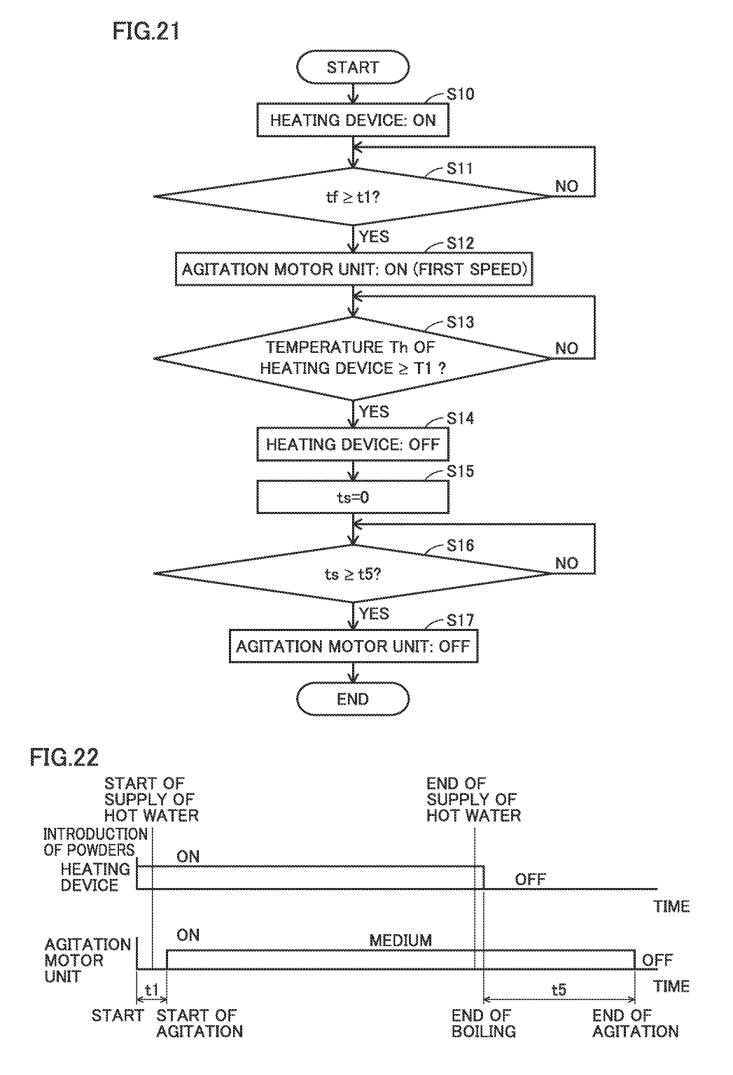

FIG. 21 is a diagram showing a flow of preparation of tea with the beverage preparation apparatus according to the present embodiment. FIG. 22 is a timing chart in preparation of tea with the beverage preparation apparatus according to the present embodiment. A method of preparing tea with beverage preparation apparatus 1 according to the present embodiment will be described with reference to FIGS. 21 and 22.

As shown in FIGS. 21 and 22, in preparation of tea, initially, tea leaf powders obtained by milling unit 300 are introduced into agitation tank 510. Since agitation blade 550 is provided at the bottom portion of agitation tank 510, agitation blade 550 can perform agitation with a small amount of hot water being supplied as will be described later. Tea leaf powders are preferably introduced at a position distant from agitation blade 550 so as not to directly receive hot water which is falling from the supply port into agitation tank 510. Tea leaf powders can be prevented from scattering due to momentum of hot water which falls from the supply port in a step which will be described later.

Simultaneously with or after introduction of tea leaf powders, in a step (S10), control portion 110 drives heating device 200. Heating device 200 is driven, for example, as a user presses a hot water supply start button provided in apparatus main body 100. Specifically, as the hot water supply start button is pressed, a hot water supply start signal is input to control portion 110. Control portion 110 drives heating device 200 based on the hot water supply start signal.

In succession, in a step (S11), control portion 110 determines whether or not an elapsed time period of tf seconds since drive of heating device 200 is equal to or longer than t1 seconds. When it is determined that the elapsed time period of tf seconds is equal to or longer than t1 seconds (step S11; YES), control portion 110 performs a step (S12). When it is determined that the elapsed time period of tf seconds is shorter than t1 seconds (step S11; NO), control portion 110 maintains a state that heating device 200 is driven until the elapsed time period of tf seconds is equal to or longer than t1 seconds. For example, the time period of t1 seconds is set approximately to 60 seconds. The time period of t1 seconds is preferably a stand-by time period until a minimum necessary amount of hot water for dissolving tea leaf powders is stored in agitation tank 510.

During a period until elapsed time period tf reaches t1 seconds, water in liquid supply path 150 is heated by heating device 200 so that a pressure in liquid supply path 150 attains to a prescribed pressure or higher. As the pressure in liquid supply path 150 attains to the prescribed pressure or higher, supply of hot water to agitation tank 510 is started. For example, supply of hot water into agitation tank 510 is started after lapse of approximately 15 to 20 seconds since drive of heating device 200. In order to sterilize water, water is preferably heated to a temperature not lower than 80° C.

Then, in the step (S12), control portion 110 drives agitation motor unit 140 and rotationally drives agitation blade 550. Specifically, control portion 110 rotationally drives agitation blade 550 at a first speed after supply of hot water into agitation tank 510 described above is started and before supply of hot water ends. Agitation blade 550 is rotationally driven after lapse of approximately 25 to 30 seconds since start of supply of hot water.

In this case, control portion 110 preferably controls agitation motor unit 140 so as to rotationally drive agitation blade 550 after hot water is supplied to agitation tank 510 until the upper end of agitation blade 550 is immersed in hot water.

By supplying hot water into agitation tank 510 until the upper end of agitation blade 550 is immersed in hot water, all introduced powders can reliably be immersed in hot water. Since a considerable amount of hot water has been supplied in such a state, hot water and powders can be prevented from scattering to the surroundings due to agitation.

Even when the upper end of agitation blade 550 is not immersed in hot water, rotational drive of agitation blade 550 may be started so long as a minimum amount of hot water necessary for dissolving tea leaf powders is supplied and a minimum amount of hot water to such an extent that scattering of hot water and powders due to agitation does not occur is supplied.

In succession, in a step (S13), control portion 110 determines whether or not a temperature Th of heating device 200 is equal to or higher than a prescribed temperature T1 based on temperature information input from thermistor 201. When whole hot water in liquid supply path 150 is supplied into agitation tank 510, heat from heating device 200 is no longer transmitted to hot water and a temperature of heating device 200 increases. Therefore, by determining whether a temperature of heating device 200 is equal to or higher than a prescribed temperature, whether or not whole hot water in liquid supply path 150 has been supplied to agitation tank 510 is determined.

When it is determined that temperature Th of heating device 200 is equal to or higher than prescribed temperature T1 (step S13; YES), control portion 110 performs a step (S14). When it is determined that temperature Th of heating device 200 is lower than prescribed temperature T1 (step S13; NO), control portion 110 maintains a state that heating device 200 is driven until temperature Th of heating device 200 attains to prescribed temperature T1 or higher.

Then, in the step (S14), control portion 110 stops drive of heating device 200. Boiling thus ends. In succession, in a step (S15), control portion 110 starts counting an elapsed time period ts, with time period ts elapsed since end of boiling being defined as 0 second.

In succession, in a step (S16), control portion 110 determines whether or not the elapsed time period of ts seconds is equal to or longer than t5 seconds. When it is determined that elapsed time period ts is equal to or longer than t5 seconds (step S16; YES), control portion 110 performs a step (S17). When it is determined that elapsed time period ts is shorter than t5 (step S16; NO), control portion 110 controls agitation motor unit 140 so as to continue rotational drive of agitation blade 550 until elapsed time period ts is equal to or longer than t5 seconds. For example, the time period of t5 seconds is set approximately to 45 to 90 seconds. Production of fine foams is promoted by continuing agitation at least for approximately 45 seconds.

Then, in the step (S17), control portion 110 stops drive of agitation motor unit 140 and stops rotational drive of agitation blade 550. Thus, agitation of tea leaf powders and hot water by agitation blade 550 ends.

During a period from start of drive of agitation motor unit 140 in the step (S12) until stop of drive of agitation motor unit 140 in the step (S17), agitation motor unit 140 is driven at a drive input value at constant intensity. For example, agitation motor unit 140 is under PWM control and controlled such that a duty ratio is constant from start of drive of agitation motor unit 140 until stop of drive.

Thus, agitation blade 550 is rotationally driven at a speed not higher than a first speed until end of agitation since rotational drive at the first speed during supply of hot water into agitation tank 510. For example, the first speed is approximately from 1200 rpm to 1800 rpm.

As described above, in beverage preparation apparatus 1 according to the present embodiment, agitation blade 550 is rotated during supply of hot water into agitation tank 510. Therefore, agitation blade 550 is rotated with an amount of hot water being smaller than in an example in which agitation blade 550 is rotated after supply of whole hot water necessary for preparation of a beverage.

In this case, agitation of hot water and tea leaf powders can be started before tea leaf powders generally absorb moisture and form a large lump (clumping). Therefore, tea leaf powders can readily be dispersed in hot water and tea leaf powders in a lump can be prevented from being produced. Since agitation can be started while an amount of supplied hot water is small and a concentration is high, fine foams are likely to be produced.

As set forth above, in beverage preparation apparatus 1 according to the present embodiment, control portion 110 rotationally drives agitation blade 550 after supply of hot water from supply port 153 to agitation tank 510 is started and before supply of hot water into agitation tank 510 ends, so that a well foamed beverage can be prepared while powders remaining in a lump are suppressed.

By rotationally driving agitation blade 550 at the first speed after supply of hot water from supply port 153 to agitation tank 510 and before end of supply of hot water into agitation tank 510 and controlling agitation motor unit 140 such that a speed of rotation of agitation blade 550 is not higher than the first speed until end of agitation by agitation blade 550, creamy foams small in diameter can sufficiently remain until end of agitation without foams formed at an initial stage of agitation being broken.

### Second Comparative Example

(Preparation of Tea)

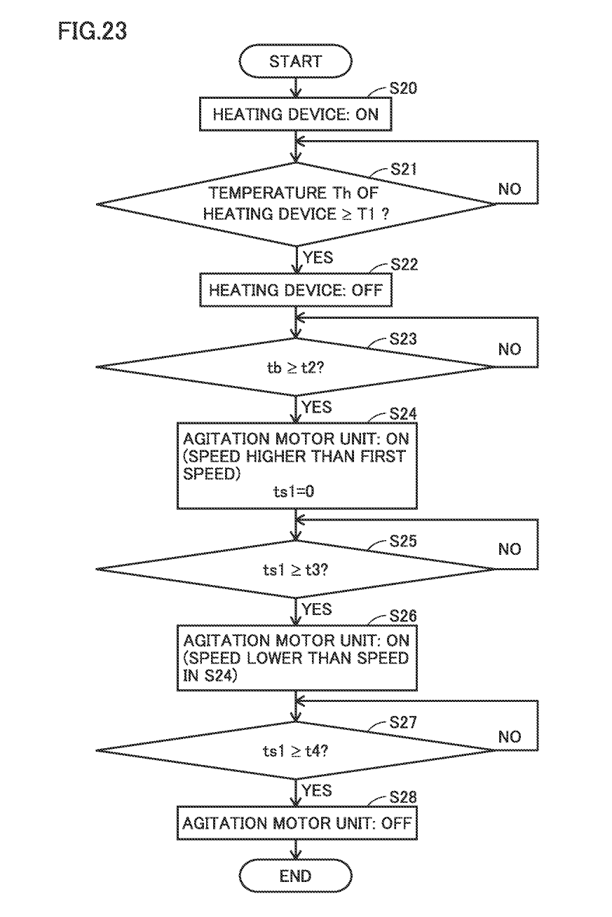

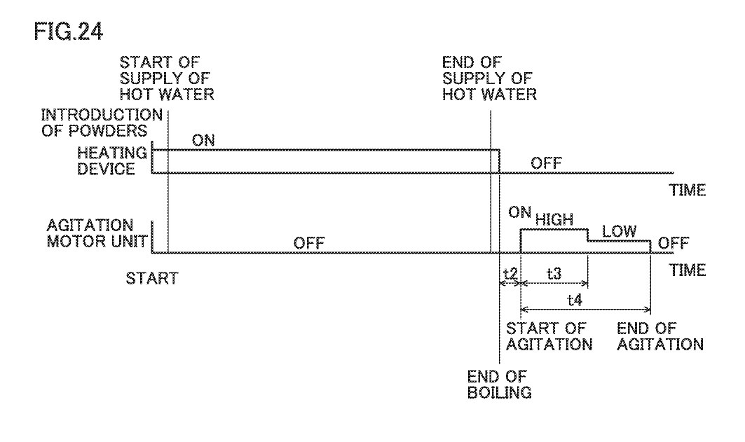

FIG. 23 is a diagram showing a flow of preparation of tea with a beverage preparation apparatus in a second comparative example. FIG. 24 is a timing chart in preparation of tea with the beverage preparation apparatus in the second comparative example. A method of preparing tea with the beverage preparation apparatus according to the second comparative example will be described with reference to FIGS. 23 and 24.

As shown in FIGS. 23 and 24, the beverage preparation apparatus according to the second comparative example is different from the beverage preparation apparatus according to the first embodiment in agitation operation by agitation blade 550 but otherwise substantially the same in operations and features of the apparatus.

In the present comparative example as well, in preparation of tea, initially, tea leaf powders obtained by milling unit 300 are introduced into agitation tank 510. Simultaneously with or after introduction of tea leaf powders, in a step (S20), control portion 110 drives heating device 200.

Then, in a step (S21), control portion 110 determines whether or not temperature Th of heating device 200 is equal to or higher than prescribed temperature T1 based on temperature information input from thermistor 201.

When it is determined that temperature Th of heating device 200 is equal to or higher than prescribed temperature T1 (step S21; YES), control portion 110 performs a step (S22). When it is determined that temperature Th of heating device 200 is lower than prescribed temperature T1 (step S21; NO), control portion 110 maintains a state that heating device 200 is driven until temperature Th of heating device 200 is equal to or higher than prescribed temperature T1.

In succession, in the step (S22), control portion 110 stops drive of heating device 200. Boiling thus ends.

Then, in a step (S23), whether or not an elapsed time period tb since stop of drive of heating device 200 is equal to or longer than t2 seconds is determined. When it is determined that elapsed time period tb is equal to or longer than t2 seconds (step S23; YES), control portion 110 performs a step (S24). When it is determined that elapsed time period tb is shorter than t2 (step S23; NO), control portion 110 maintains a state that drive of heating device 200 remains stopped until elapsed time period tb is equal to or longer than t2 seconds. For example, the time period of t2 seconds is set approximately to 10 seconds. If the agitation motor is rotated at a high speed while water is vigorously boiled, hot water scatters around. Therefore, stand-by for t2 seconds is preferred so that an operation in a next step is started after boiling is settled.

In succession, in the step (S24), control portion 110 drives agitation motor unit 140. Specifically, agitation blade 550 is rotationally driven at a speed higher than the first speed according to the embodiment. Control portion 110 starts counting of an elapse time period ts1, with time period ts1 elapsed since start of drive of agitation motor unit 140 being defined as 0 second.

In rotationally driving agitation blade 550 at a speed higher than the first speed according to the embodiment, a drive input value at which agitation motor unit 140 is driven is set to be greater than the drive input value according to the first embodiment. Specifically, a duty ratio is set to be higher than in the first embodiment. For example, the number of revolutions of agitation blade 550 is set to 2000 rpm.

Then, in a step (S25), whether or not elapsed time period ts1 since stop of drive of heating device 200 is equal to or longer than t3 seconds is determined. When it is determined that elapsed time period ts1 is equal to or longer than t3 seconds (step S25; YES), control portion 110 performs a step (S26). When it is determined that elapsed time period ts1 is shorter than t3 (step S25; NO), control portion 110 controls agitation motor unit 140 so as to continue rotational drive of agitation blade 550 at the speed described above until elapsed time period ts1 is equal to or longer than t3. For example, the time period of t3 seconds is set approximately to 45 seconds.

In succession, in the step (S26), control portion 110 controls agitation motor unit 140 so as to rotationally drive agitation blade 550 at a speed lower than the speed described above continued in the step (S25). A duty ratio in the steps (S24) and (S25) described above is set approximately to half. For example, the number of revolutions of agitation blade 550 is set to 1000 rpm.

Then, in a step (S27), control portion 110 determines whether or not the elapsed time period of ts1 seconds is equal to or longer than t4 seconds. When it is determined that elapsed time period ts1 is equal to or longer than t4 seconds (step S27; YES), control portion 110 performs a step (S28). When it is determined that elapsed time period ts1 is shorter than t4 (step S27; NO), control portion 110 controls agitation motor unit 140 so as to continue rotational drive of agitation blade 550 at the speed adjusted in the step (S26) until elapsed time period ts1 is equal to or longer than t4 seconds. For example, the time period of t4 seconds is set to 90 seconds. The time period of t4 seconds refers to a total time period for agitation in the comparative example.

In succession, in the step (S28), control portion 110 stops drive of agitation motor unit 140 and stops rotational drive of agitation blade 550. Thus, agitation of tea leaf powders and hot water by agitation blade 550 ends.

In the beverage preparation apparatus in the second comparative example, agitation blade 550 is rotationally driven after whole hot water necessary for preparation of a beverage is supplied into agitation tank 510. Since a considerable time period has elapsed since start of supply of hot water by the time of rotation of agitation blade 550, tea leaf powders introduced from the powder inlet and accumulated like a mountain during that period tend to generally absorb hot water and form a lump (clumping).

In order to break tea leaf powders in such a form of a large lump, in the comparative example, agitation blade 550 should be rotated in the steps (S24) and (S25) faster than in the first embodiment. Therefore, large noise may be generated with rotation of agitation blade 550 and a user may feel uncomfortable. Even when a speed of agitation by agitation blade 550 is set to be high, tea leaf powders in a form of a large lump may not completely be broken and tea leaf powders in a lump may remain.

In general, as a concentration of tea in which tea leaf powders are dispersed is higher, foaming tends to be better. In the comparative example, however, hot water and tea are agitated after a considerable amount of hot water is stored in agitation tank 510. Since tea is foamed with agitation blade 550 and agitation is performed with the number of revolutions being increased while a concentration of tea is low, foams large in diameter are produced. By crushing foams large in diameter by setting a speed of rotation of agitation blade 550 to be low during a period after lapse of t3 seconds until lapse of t4 seconds, foams can be decreased in diameter to some extent, however, it is difficult to produce fine and creamy foams.

### Second Embodiment

(Preparation of Tea)

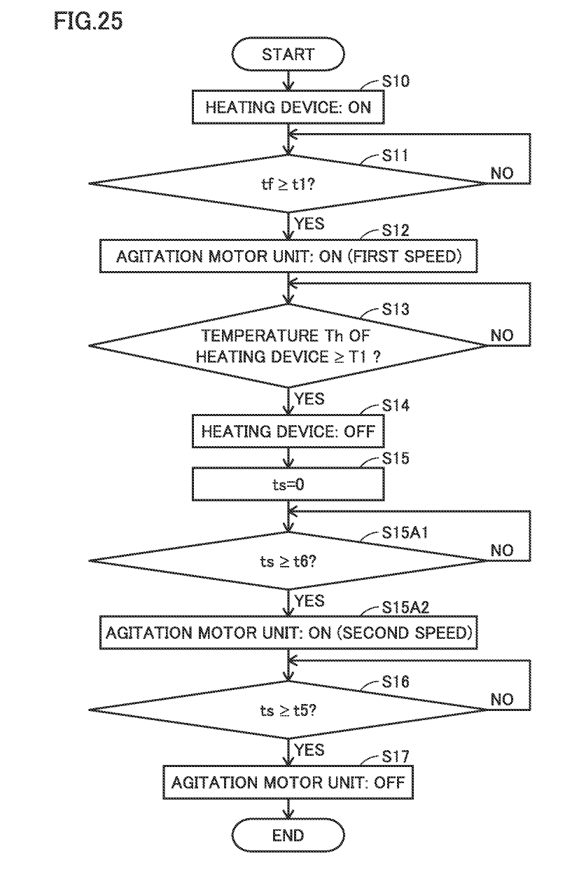

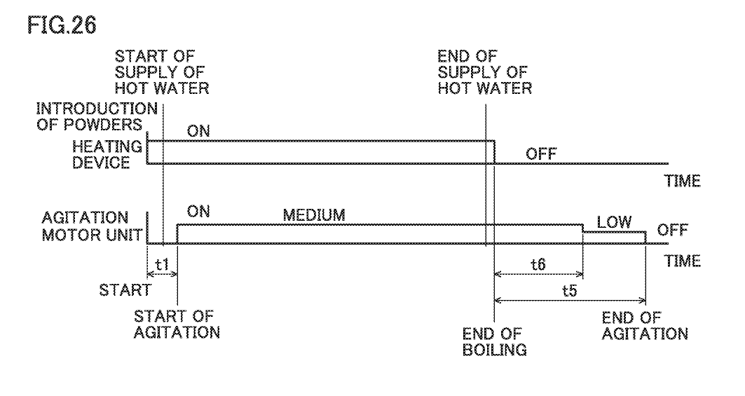

FIG. 25 is a diagram showing a flow of preparation of tea with a beverage preparation apparatus according to the present embodiment. FIG. 26 is a timing chart in preparation of tea with the beverage preparation apparatus according to the present embodiment. A method of preparing tea with the beverage preparation apparatus according to the present embodiment will be described with reference to FIGS. 25 and 26.

As shown in FIGS. 25 and 26, the beverage preparation apparatus according to the present embodiment is different from beverage preparation apparatus 1 according to the first embodiment in agitation operation by agitation blade 550 during a period from end of supply of hot water into agitation tank 510 until end of agitation by agitation blade 550 but otherwise substantially the same in operations and features of the apparatus.

In the method of preparing tea with the beverage preparation apparatus according to the present embodiment, operations in the step (S10) to the step (S15) substantially the same as in the method of preparing tea with the beverage preparation apparatus according to the first embodiment are performed.

Then, in a step (S15A1), control portion 110 determines whether or not the elapsed time period of ts seconds is equal to or longer than t6 seconds. When it is determined that elapsed time period ts is equal to or longer than t6 seconds (step S15A1; YES), control portion 110 performs a step (S15A2). When it is determined that elapsed time period ts is shorter than t6 (step S15A1; NO), control portion 110 controls agitation motor unit 140 so as to continue rotational drive of agitation blade 550 at the first speed until elapsed time period ts is equal to or longer than t6 seconds. The time period of t6 seconds is shorter than t5 seconds. For example, the time period of t5 seconds is set approximately to 90 seconds and the time period of t6 seconds is set approximately to 45 seconds. The time period of t6 seconds is a time period for agitation for accelerating foaming.

In succession, in the step (S15A2), control portion 110 controls agitation motor unit 140 so as to rotationally drive agitation blade 550 at a second speed lower than the first speed. Control portion 110 drives agitation motor unit 140 at a drive input value smaller than the drive input value at prescribed intensity input for rotation at the first speed. For example, agitation motor unit 140 is driven with a duty ratio being lowered.

Then, in the step (S16), control portion 110 determines whether or not the elapsed time period of ts seconds is equal to or longer than t5 seconds. When it is determined that elapsed time period ts is equal to or longer than t5 seconds (step S16; YES), control portion 110 performs the step (S17). When it is determined that elapsed time period ts is shorter than t5 (step S16; NO), control portion 110 controls agitation motor unit 140 so as to continue rotational drive of agitation blade 550 at the second speed until elapsed time period ts is equal to or longer than t5 seconds. For example, the time period of t5 seconds is set to 90 seconds. The time period of t5seconds is a time period from stop of drive of heating device 200 and end of boiling until end of agitation.

Then, in the step (S17), control portion 110 stops drive of agitation motor unit 140 and stops rotational drive of agitation blade 550. Thus, agitation of tea leaf powders and hot water by agitation blade 550 ends.

In the beverage preparation apparatus according to the present embodiment as well, control portion 110 has agitation blade 550 rotate at the first speed after supply of hot water from the supply port into agitation tank 510 and before end of supply of hot water into agitation tank 510.

Thus, agitation of hot water and tea leaf powders can be started before tea leaf powders generally absorb moisture and form a large lump (clumping). Therefore, tea leaf powders can readily be dispersed in hot water and tea leaf powders in a form of a lump can be prevented from being produced.

Since agitation can be started while an amount of supplied hot water is small and a concentration is high, fine foams tend to be produced. Though hot water is newly supplied during agitation, agitation blade 550 is rotated until end of agitation such that a speed of agitation is not higher than the first speed. Therefore, foams formed in an early stage of agitation are not broken but creamy foams small in diameter can remain until end of agitation.

In the beverage preparation apparatus according to the present embodiment, during a period from end of supply of hot water until end of agitation by agitation blade 550, agitation blade 550 is rotationally driven at the first speed for a prescribed time period (t6 seconds) and thereafter agitation blade 550 is rotationally driven at the second speed lower than the first speed.

Though fine foams can be produced as a result of rotation at the first speed when an amount of hot water supplied into agitation tank 510 is small (for example, approximately 150 cc), foams tend to disappear. Therefore, by rotating the agitation blade at the second speed lower than the first speed, even though an amount of hot water is small, foams can be prevented from disappearing and creamy foams small in diameter can remain.

### Third Embodiment

(Preparation of Tea)

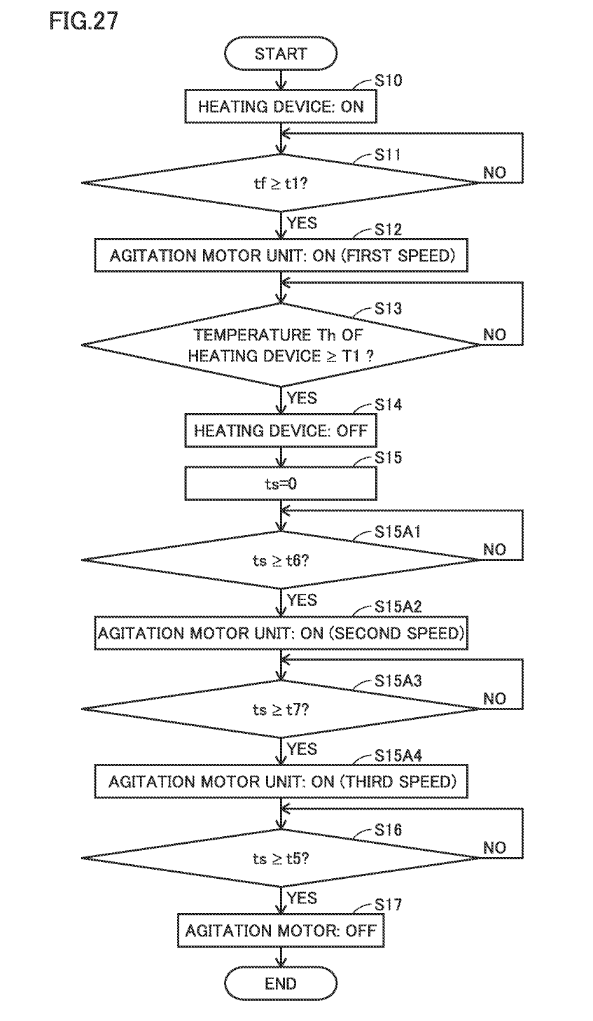

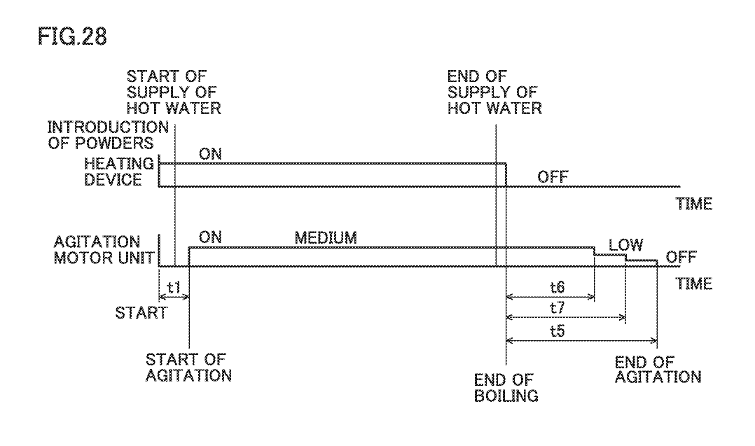

FIG. 27 is a diagram showing a flow of preparation of tea with a beverage preparation apparatus according to the present embodiment. FIG. 28 is a timing chart in preparation of tea with the beverage preparation apparatus according to the present embodiment. A method of preparing tea with the beverage preparation apparatus according to the present embodiment will be described with reference to FIGS. 27 and 28.

As shown in FIGS. 27 and 28, the beverage preparation apparatus according to the present embodiment is different from beverage preparation apparatus 1 according to the first embodiment in agitation operation by agitation blade 550 during a period from end of supply of hot water into agitation tank 510 until end of agitation by agitation blade 550 but otherwise substantially the same in operations and features of the apparatus.

In the method of preparing tea with the beverage preparation apparatus according to the present embodiment, operations in the step (S10) to the step (S15) substantially the same as in the method of preparing tea with the beverage preparation apparatus according to the first embodiment are performed.

Then, in the step (S15A1), control portion 110 determines whether or not the elapsed time period of ts seconds is equal to or longer than t6 seconds. When it is determined that elapsed time period ts is equal to or longer than t6 seconds (step S15A1; YES), control portion 110 performs the step (S15A2). When it is determined that elapsed time period ts is shorter than t6 (step S15A1; NO), control portion 110 controls agitation motor unit 140 so as to continue rotational drive of agitation blade 550 at the first speed until elapsed time period ts is equal to or longer than t6 seconds. The time period of t6 seconds is shorter than t5 seconds. For example, the time period of t6 seconds is set approximately to 45 seconds.

In succession, in the step (S15A2), control portion 110 controls agitation motor unit 140 so as to rotationally drive agitation blade 550 at the second speed lower than the first speed. Control portion 110 drives agitation motor unit 140 at a drive input value smaller than the drive input value at prescribed intensity input for rotation at the first speed. For example, agitation motor unit 140 is driven with a duty ratio being lowered.

Then, in a step (S15A3), control portion 110 determines whether or not the elapsed time period of ts seconds is equal to or longer than t7 seconds. When it is determined that elapsed time period ts is equal to or longer than t7 seconds (step S15A3; YES), control portion 110 performs a step (S15A4). When it is determined that elapsed time period ts is shorter than t7 (step S15A3; NO), control portion 110 controls agitation motor unit 140 so as to continue rotational drive of agitation blade 550 at the second speed until elapsed time period ts is equal to or longer than t7 seconds. The time period of t7 seconds is longer than t6 seconds and shorter than t5 seconds. For example, the time period of t7 seconds is approximately from 65 seconds to 70 seconds.

In succession, in the step (S15A4), control portion 110 controls agitation motor unit 140 so as to rotationally drive agitation blade 550 at a third speed lower than the second speed. Control portion 110 drives agitation motor unit 140 at a drive input value smaller than the drive input value at prescribed intensity input for rotation at the second speed. For example, agitation motor unit 140 is driven with a duty ratio being lowered.

Then, in the step (S16), control portion 110 determines whether or not the elapsed time period of ts seconds is equal to or longer than t5 seconds. When it is determined that elapsed time period ts is equal to or longer than t5 seconds (step S16; YES), control portion 110 performs the step (S17). When it is determined that elapsed time period ts is shorter than t5 (step S16; NO), control portion 110 controls agitation motor unit 140 so as to continue rotational drive of agitation blade 550 at the third speed until elapsed time period ts is equal to or longer than t5 seconds. For example, the time period of t5 seconds is set to 90 seconds.

Then, in the step (S17), control portion 110 stops drive of agitation motor unit 140 and stops rotational drive of agitation blade 550. Thus, agitation of tea leaf powders and hot water by agitation blade 550 ends.

In the beverage preparation apparatus according to the present embodiment as well, control portion 110 has agitation blade 550 rotate at the first speed after supply of hot water from the supply port into agitation tank 510 and before end of supply of hot water into agitation tank 510.

Thus, agitation of hot water and tea leaf powders can be started before tea leaf powders generally absorb moisture and form a large lump (clumping). Therefore, tea leaf powders can readily be dispersed in hot water and tea leaf powders in a form of a lump can be prevented from being produced.

Since agitation can be started while an amount of supplied hot water is small and a concentration is high, fine foams tend to be produced. Though hot water is newly supplied during agitation, agitation blade 550 is rotated until end of agitation such that a speed of agitation is not higher than the first speed. Therefore, foams formed in an early stage of agitation are not broken but creamy foams small in diameter can remain until end of agitation.

During a period from end of supply of hot water until end of agitation by agitation blade 550, control portion 110 rotationally drives agitation blade 550 at the first speed for a prescribed time period (t6 seconds) and thereafter rotationally drives agitation blade 550 at the second speed lower than the first speed for a prescribed time period (t7-t6 (seconds)), and thereafter rotationally drives agitation blade 550 at the third speed lower than the second speed for a prescribed period (t5-t7 (seconds)).

Even when an amount of hot water supplied into agitation tank 510 is further smaller (smaller than 150 cc), the number of revolutions is decreased stepwise so that creamy foams small in diameter can remain while disappearance of fine foams produced as a result of rotation at the first speed is suppressed.

Though the embodiments of the present invention have been described above, the embodiments disclosed herein are illustrative and non-restrictive in every respect. The scope of the present invention is defined by the terms of the claims and is intended to include any modifications within the scope and meaning equivalent to the terms of the claims.

### REFERENCE SIGNS LIST

1 beverage preparation apparatus; 100 apparatus main body; 110 control portion; 111 air inlet; 112 air filter; 115 fan; 130 milling driving force coupling mechanism; 140 agitation motor unit; 140A contactless table; 141 magnet; 150 liquid supply path; 151 connection pipe; 152 supply nozzle; 152A intermediate member; 152B partition portion; 153 supply port; 154 air outlet chamber; 155 fitting portion; 160 air passage path; 161 connection duct; 162 air duct; 163 air outlet; 164 inner wall portion; 165 insertion portion; 170 path formation member; 171 upper member; 172 lower member; 172A bottom portion; 172B peripheral wall portion; 180 milling unit attachment portion; 190 agitation unit attachment portion; 195 liquid storage tank attachment portion; 200 heating device; 201 thermistor; 210 first paddle; 210a accommodation portion; 210h space; 211 second paddle; 212 paddle surface; 220 blade portion; 222 lower auxiliary ring; 223 upper auxiliary ring; 240 magnet; 250 cylindrical core; 251 conical cap; 252 ring seal; 253 through hole; 260a cover; 260b paddle main body; 300 milling unit; 300W window for coupling; 310 milling case; 310b upper end opening portion; 311 storage portion; 312 discharge path; 312a discharge outlet; 315 safety rib; 320 hopper; 330 cover portion; 340 lower mill support portion; 343 powder scraping portion; 345 milling shaft; 350 lower mill; 355 core; 355a helical blade; 360 upper mill; 370 upper mill holding portion; 380 spring; 390 spring holding member; 500, 500X agitation unit; 510 agitation tank; 513 opening portion; 515 lip portion; 520 grip; 530, 530X agitation cover; 531, 531X hot water supply inlet; 532 powder inlet; 533 hole portion; 534 opening portion; 535 slide cover; 540 discharge port opening and closing mechanism; 541 discharge port; 542 operation lever; 543 opening and closing nozzle; 550 agitation blade; 560 rotation shaft; 700 liquid storage tank; 710 tank main body; 720 lid portion; 730 check valve; 800 tea leaf powder tray; and 900 placement base.

1. A beverage preparation apparatus for preparing a beverage with a liquid and powders, the beverage preparation apparatus comprising:
a liquid storage tank storing the liquid;
a liquid supply path having one end connected to the liquid storage tank and the other end serving as a supply port supplying the liquid to outside;
a heating device for heating the liquid in the liquid supply path;
an agitation tank accommodating an agitation member agitating the powders and the liquid heated by the heating device and supplied through the supply port;
an agitation member drive portion rotationally driving the agitation member; and
a control portion controlling the agitation member drive portion,
the control portion rotationally driving the agitation member after supply of the liquid from the supply port to the agitation tank is started and before supply of the liquid to the agitation tank ends.

2. The beverage preparation apparatus according to claim 1, wherein
the control portion rotationally drives the agitation member at a first speed after supply of the liquid from the supply port to the agitation tank is started and before supply of the liquid to the agitation tank ends and controls the agitation member drive portion such that a speed of rotation of the agitation member is not higher than the first speed until end of agitation by the agitation member.

3. The beverage preparation apparatus according to claim 2, wherein
during a period from end of supply of the liquid until end of agitation by the agitation member, the control portion rotationally drives the agitation member at a second speed lower than the first speed after the control portion rotationally drives the agitation member at the first speed for a prescribed time period.

4. The beverage preparation apparatus according to claim 1, wherein
the control portion controls the agitation member drive portion so as to rotationally drive the agitation member after the liquid is supplied to the agitation tank until an upper end of the agitation member is immersed.

5. The beverage preparation apparatus according to claim 1, wherein
the agitation member is provided at a bottom portion of the agitation tank.
